(19) United States
(12) Patent Application Publication
(10) Pub. No.: US 2010/0230513 A1
(43) Pub. Date: Sep. 16, 2010

(54) SPRAY NOZZLE

(76) Inventor: Harold D. Curtis, Oklahoma City, OK (US)

Correspondence Address: DUNLAP CODDING, P.C., PO BOX 16370, OKLAHOMA CITY, OK, 73113, US

(21) Appl. No.: 12/788,943

(22) Filed: May 27, 2010

(30) Foreign Application Priority Data
Nov. 26, 2008 (US) PCT/US08/84889

(51) Int. Cl. B05B 3/04

(52) U.S. Cl. 239/240

(57) ABSTRACT

A spray nozzle having a tubular nozzle body with a fluid passage defined by an annular surface substantially square shaped in configuration causing a fluid exiting the nozzle body to exit as a substantially square shaped column of fluid and a turbine positioned below the nozzle body to distribute the square shaped column of fluid into a substantially square shaped spray pattern.

### CROSS-REFERENCE TO RELATED APPLICATIONS

This application claims the benefit of PCT Application Serial No. U.S. 08/84889, filed Nov. 26, 2008, which claims the benefit of U.S. Provisional Application Ser. No. 60/990,432, filed Nov. 27, 2007, U.S. Provisional Application Ser. No. 61/080,057, filed Jul. 11, 2008, and U.S. Provisional Application Ser. No. 61/196,451, filed Oct. 17, 2008, the contents of each being incorporated herein by reference.

### BACKGROUND OF THE INVENTION

1. Field of the Invention

The present invention relates generally to a spray nozzle, and more particularly, but not by way of limitation, to an improved spray nozzle that is constructed to produce a substantially square shaped column of water and distribute the substantially square shaped column of water into a substantially square shaped spray pattern.

2. Brief Description of Related Art

Cooling towers typically utilize a grid work of overhead nozzles to form a plurality of overlapping or closely-adjacent spray patterns for the purpose of distributing water over the upper surface of a layer of fill material through which air is drawn. The water flows downward through or across the fill material whereby thermal energy is transferred from the water to surrounding air so as to cool the water.

It is important to distribute the water as uniformly as possible over the upper surface of the fill material so that the water will uniformly flow through the fill material across the entire cross-sectional area of the tower. If the water distribution is not uniform, channels of uneven water loading may develop which cause the formation of low pressure paths through which the air will channel, thus greatly reducing the efficiency of the heat exchange operation conducted by the cooling tower.

It has been found that the efficiency of the heat exchange operation is greatly increased by using fluid distributing devices or nozzles that will create a plurality of abutting or overlapping square spray patterns, such as that disclosed in U.S. Pat. No. 5,152,458, the entire contents of which are hereby incorporated herein by reference. The formation of square spray patterns enables the spray patterns to be mated with each other so that voids or gaps do not exist between adjacent spray patterns. However, inefficiencies may still occur if the fluid distributed by each nozzle is not distributed uniformly across each of the individual square spray patterns.

One example of an improved nozzle is disclosed in U.S. patent application Ser. No. 11/223,583 (U.S. Pub. No. 2006/0038046), which is hereby incorporated by reference in its entirety. However, a number of shortcomings are still present within the nozzles heretofore known in the art. Specifically, a perpetual need exists for nozzles that are less susceptible to clogging, and that more evenly and reliably distribute water in a desired pattern. It is to such a spray nozzle that the present invention is directed.

### DESCRIPTION OF THE SEVERAL VIEWS OF THE DRAWINGS

FIG. 1 is a perspective view of a spray nozzle constructed in accordance with the present invention.

FIG. 2 is an exploded, perspective view of the spray nozzle of FIG. 1 having a tubular adapter.

FIG. 3 is an exploded, perspective cross-sectional view of the spray nozzle of FIG. 2.

FIGS. 4A-4B are perspective views of a turbine.

FIG. 4C is a top plan view of the turbine of FIGS. 4A-4B.

FIG. 4D is a bottom plan view of the turbine of FIGS. 4A-4B.

FIGS. 5A-5B are perspective views of another turbine.

FIG. 5C is a top plan view of the turbine of FIGS. 5A-5B.

FIG. 5D is a bottom plan view of the turbine of FIGS. 5A-5B.

FIGS. 6A-6B are perspective views of another turbine.

FIG. 6C is a top plan view of the turbine of FIGS. 6A-6B.

FIG. 6D is a bottom plan view of the turbine of FIGS. 6A-6B.

FIGS. 7A-7B are perspective views of another turbine having a notched deflector plate.

FIG. 7C is a top plan view of the turbine of FIGS. 7A-7B.

FIG. 7D is a bottom plan view of the turbine of FIGS. 7A-7B.

FIGS. 8A-8B are perspective views of another turbine having a deflector plate.

FIG. 8C is a top plan view of the turbine of FIGS. 8A-8B.

FIG. 8D is a bottom plan view of the turbine of FIGS. 8A-8B.

FIG. 9 is a top schematic view of a cooling tower cell having a plurality of spray nozzles constructed in accordance with the present invention and arranged in a zonal pattern.

FIG. 10 is a perspective view of a spray nozzle having a deflector plate and schematically illustrating an interchangeable turbine.

FIG. 11 is a perspective view of the deflector plate.

FIG. 12 is a side elevation view of the deflector plate of FIG. 11.

FIG. 13 is a side elevational view of the spray nozzle of FIG. 10 disposed adjacent to the side of a cooling tower cell.

### DETAILED DESCRIPTION OF THE INVENTION

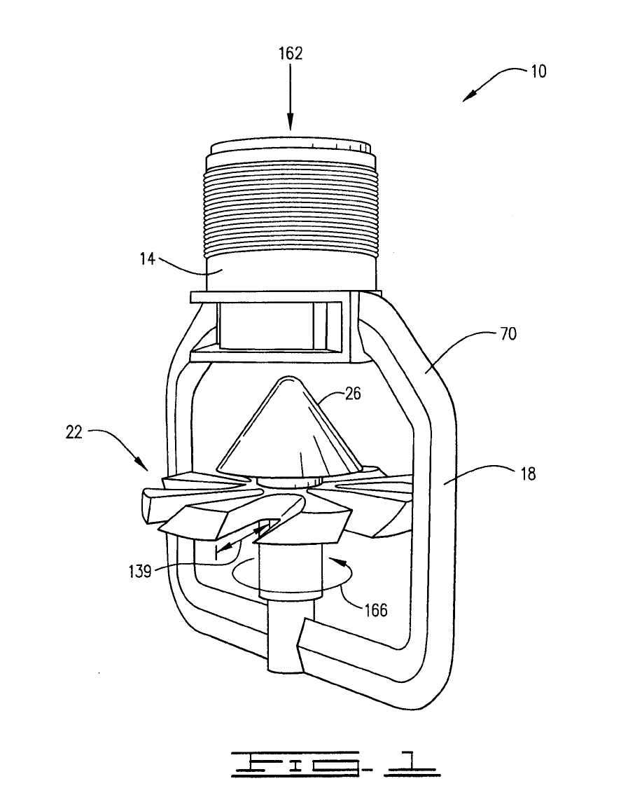

Referring now to the drawings, and more particularly to FIGS. 1-4D, shown therein is a spray nozzle 10 constructed in accordance with the present invention. The spray nozzle 10 includes a nozzle body 14, a cradle 18, a turbine 22, and a turbine cap 26. Unless otherwise noted for specific parts or portions, the nozzle body 14, the cradle 18, the turbine 22, and the turbine cap 26 are preferably formed of a durable, polymeric material, such as nylon or acetyl. In other embodiments, the nozzle body 14, the cradle 18, the turbine 22, and the turbine cap 26 may be formed of any suitably-durable material, such as carbon fiber, aluminum, ceramic, steel, stainless steel, alloy, or the like.

The nozzle body 14 is a generally tubular member defining a fluid passage 30. The nozzle body 14 has an inlet end 34 for connecting the nozzle body 14 to a fluid distributing header (not shown) and an outlet end 38. An annular surface 42 extends from the inlet end 34 to the outlet end 38, and transitions the fluid passage 30 from a substantially circular opening at the inlet end 34 to a substantially square shaped opening at the outlet end 38. In other embodiments, the annular surface 42 may define any suitably-shaped transition, such as triangular, pentagonal, hexagonal, and the like. In contrast to other nozzles having a connection member extending into their respective passages, the fluid passage 30 of the nozzle 10 is preferably substantially smooth and free of protrusions and the like so as to provide substantially even flow within the passage 30. The spray nozzle 10 may also further include a tubular adapter 36 which is adapted to fit within the nozzle body 14 by slidable insertion into the inlet end 34 of the nozzle body 14 and operates to reduce the area of the fluid passage 30 to restrict fluid flow through the nozzle body 14 to a desired flow rate. Similarly to the nozzle body 14, the tubular adapters 36 define a fluid passage 37 which transitions from a substantially circular opening at an inlet to a substantially square shaped opening at an outlet end.

The nozzle body 14 further includes a pair of reinforced portions 46 adjacent the outlet end 38. The reinforced portion 46 includes two spaced-apart ribs 50 circumscribing the nozzle body 14, as well as two anchor portions 54, as shown. The anchor portions 54 are preferably disposed adjacent to opposing vertices of the outlet end 38. Each of the anchor portions 54 also defines an opening 58 sized to receive a portion of the cradle 18, as will be described in more detail below. In one embodiment, the opening is provided with a cylindrical hole 62 extending the full depth of the anchor portion 54, so as to receive a portion of the cradle 18, such that a lower portion 66 may engage a portion of the cradle 18, as will be described in more detail below. In other embodiments, the configuration or construction of the reinforced portion 46 may be modified in any suitable way. For example, the reinforced portion may be provided with any suitable number of ribs 50, anchor portions 54, and/or the like.

The cradle 18 has a C-shaped body member 70, a pair of connection members 74, and an axle 78. The body member 70 is provided with a flattened, blade-like cross section having relatively thin lateral edges 82 and a relatively thick medial portion 86. The connection members 74 are integrally formed with the body member 70 and are formed with a cylindrical shape, as shown, corresponding to the openings 58 defined in the anchor portions 54 of the nozzle body 14. As also shown, the shape of the body member 70 corresponds to the cylindrical hole 62 (or vice versa) of the openings 58. The connection members 74 further include extension portions 90 that extend beyond the body member 70 and engage at least a portion of the anchor portions 54. The axle 78 is integrally formed with the body member 70 and is provided with a substantially-cylindrical shape extending inwardly from the body member 70, as shown. The axle 78 defines a groove 94 having a concave or arcuate shape and extending about the axle 78, as shown. The axle 78 extends a length 98 past the groove 94, and terminates at an end 102. As also shown, the perimeter of the end 102 is provided with a chamfer or fillet 106 so as to reduce potential interference with the turbine 22, as will be apparent from the description below.

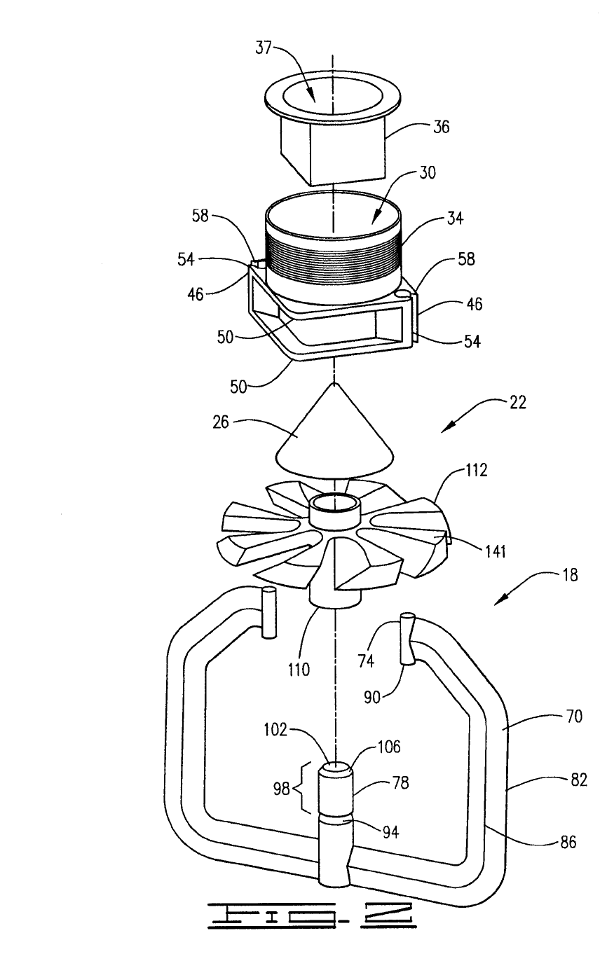

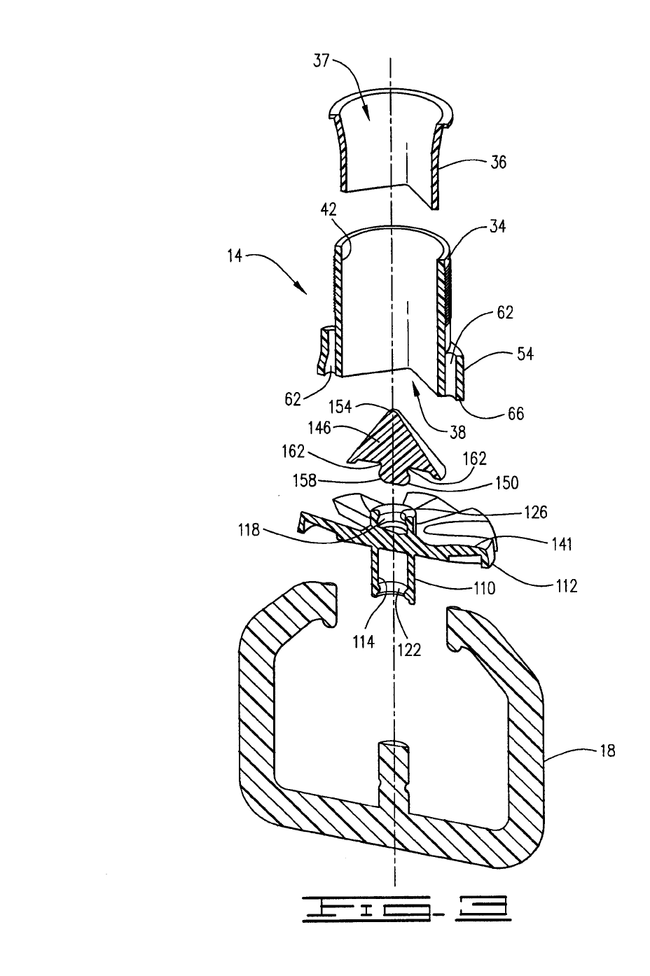

Referring to FIGS. 3-4D, the turbine 22 includes a central hub portion 110 and a plurality of blades 112. The hub portion 110 has a lower axial opening 114 and an upper axial opening 118 defined therein. The lower and upper openings 114 and 118, respectively, are cylindrical and coaxially formed with one another and with the hub portion 110. The lower opening 114 is provided with a circumferential protrusion 122 therein corresponding in shape and size to the groove 94. However, the protrusion 122 is at least slightly smaller than the groove 94 such that in operation, where the protrusion 122 is received within the groove 94, the turbine 22 may freely spin or rotate about the axle 78 while being prevented from substantial axial movement relative to the axle 78. The protrusion 122 is disposed such that, when the nozzle 10 is assembled, the hub portion 110 is held in spaced-apart relation to the body portion 70 of the cradle 18, to prevent interference therebetween. Additionally, the opening 114 is formed with a length at least slightly greater than the length 98 of the axle 78 such that end 102 is at least slightly spaced apart from the bottom or internal end of the lower opening 114, also to prevent interference therebetween and to facilitate assembly of the nozzle 10, as will be described in more detail below.

The turbine 22 is formed such that the hub portion 110 is flexible and resilient enough that the hub portion 110 may be assembled by aligning the lower opening 114 with the axle 78 and pressing the turbine 22 thereon. More specifically, the hub portion 110 flexes outwardly enough to permit the protrusion 122 to expand and fit over the end 102 (facilitated by the chamfer or fillet 106) and be pushed over the axle 78 to the point where the protrusion 122 aligns with the groove 94, whereupon the protrusion 122 may resiliently contract so as to be disposed at least partially within the groove 94 and retain the turbine 22 in substantially-fixed axial relation to the axle 78.

The upper opening 118 is formed substantially similar to the lower opening 114. That is, the hub portion 110 is provided with a protrusion 126 circumscribing the upper opening 118 in similar fashion to the protrusion 122 relative to the lower opening 114. In this way, the hub portion 110 is permitted to interact with the turbine cap 26, as will be described in more detail below.

The plurality of blades 112 are integrally formed with the hub portion 110. By way of non-limiting example, the turbine 22 is provided with eight blades 112 which are substantially symmetrical and are spaced at substantially equal angular increments about the hub portion 110. As shown in FIGS. 4A-4D, each blade 112 has a height 130 (FIG. 3), a leading edge 134, a trailing edge 138, a trailing surface 140 and a top surface 141. The leading edge 134 has a length 139 (FIG. 1) and is formed with a substantially constant angle along the length 139 of the blade 112. The angle of the leading edge 134 is between about 90 degrees and about 25 degrees, more between about 80 degrees and about 35 degrees, and most about 70 degrees (as shown). The angle of the trailing edge 138 is between about 15 degrees and about 75 degrees, more between about 30 degrees and about 60 degrees, and most about 45 degrees (as shown). The top surface 141 is substantially flat along the length of the blade 112. The substantially flat configuration of the top surface 141 operates to distribute water in a more horizontal direction relative to the blades 112 and is designed for use in cooling towers where the spray nozzle 10 is installed at a fall distance 171 ranging from approximately sixteen inches to approximately twenty four inches above the fill media 192 (FIG. 13). The trailing edge 138 has a smaller or relatively flatter angle than the leading edge 134 and tapers toward the hub portion 110. Additionally, each leading edge 134 is disposed relative to the next adjacent trailing edge 138 such that the space therebetween increases as the distance from the hub portion 110 increases. The length 139 of each blade 112 is shown nearest to the hub portion 110 at which the leading edge 134 terminates, and may occur at any distance away from the hub portion 110. However, it will be understood that the length 139 of each blade may vary according to design requirements.

As best shown in FIG. 4B, each blade 112 may further include a recessed portion 142 on the lower side of the blade 112, as shown, so as to reduce the mass of each blade 112 and thereby reduce the mass of the turbine 22.

Referring back to FIG. 3, the turbine cap 26 has a body portion 146 and a connection portion 150. The body portion 146 is provided with a frusto-conical shape, that is, is shaped as a cone with a rounded tip 154. The connection portion 150 is provided with an enlarged end 158 that cooperates with the body portion 146 to define a groove 162 between the body portion 146 and the enlarged end 158. The enlarged end 158 is sized to engage the internal surface of the hub portion 110 that defines the upper opening 118. Similarly, the groove 162 is of approximately equal, or slightly smaller, size than the protrusion 126 in the upper opening 118 such that the protrusion 126 firmly engages the connection portion 150 when the protrusion is disposed within the groove 162. As described above with respect to the lower opening 114 and the axle 78, the hub portion 110 of the turbine 22 is constructed such that the turbine cap 26 and the turbine 22 may be assembled by aligning and pressing the connection portion 150 into the upper opening 118 of the hub portion 110. More specifically, the hub portion 110 and protrusion 126 are forced to expand about the enlarged end 158 of the connection portion 150 of the turbine cap 26. In this way, when the protrusion 126 and groove 158 are aligned, the hub portion 110 resiliently contracts such that the protrusion 126 firmly engages the connection portion 150 and the enlarged end 158 of the connection portion 150 firmly engages the interior of the hub portion 110. The turbine cap 26 is thereby held in fixed relation to the turbine 22 such that both rotate in unison when the nozzle 10 operates, as will be described in more detail below.

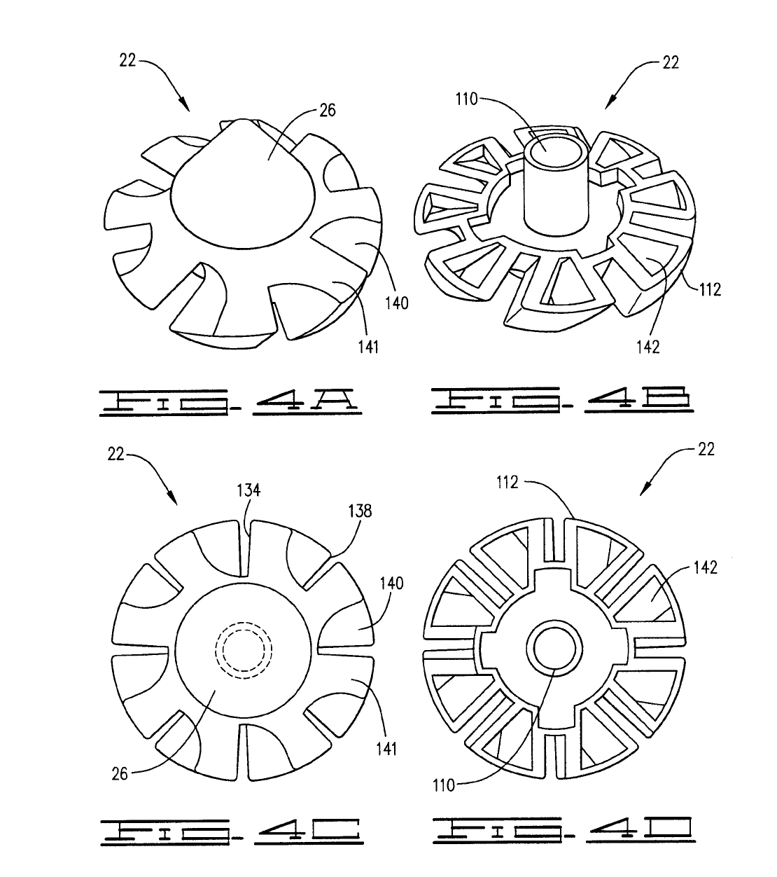

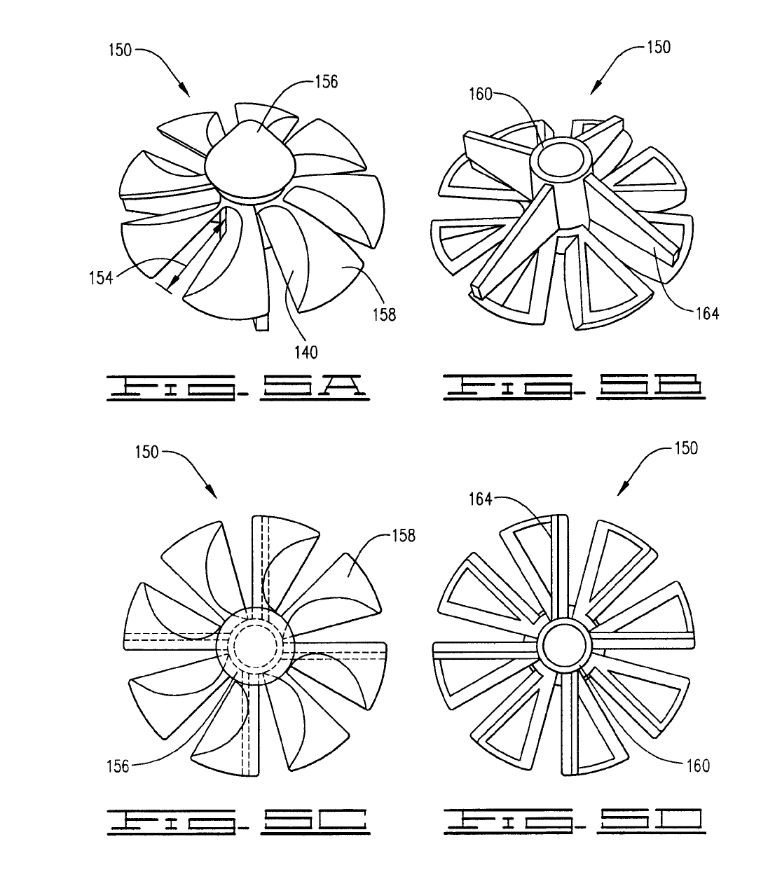

It will be understood that although the above description of the turbine 22 (FIGS. 4A-4D) has been disclosed for use with the spray nozzle 10, alternative embodiments (see FIGS. 5A-5D, 6A-6B, 7A-7D and 8A-8D) of turbine 22 may likewise be utilized. The alternative embodiments of turbine 22 will be discussed in greater detail below.

As partially described above, the nozzle 10 is assembled as follows. The connection portion 150 of the turbine cap 26 is aligned with and pressed into the upper opening 118 of the hub portion 110. The hub portion 110 and protrusion 126 are thereby forced to expand about the enlarged end 158 of the connection portion 150 of the turbine cap 26. In this way, when the protrusion 126 and groove 158 align, the hub portion 110 resiliently contracts such that the protrusion 126 firmly engages the connection portion 150 and the enlarged end 158 of the connection portion 150 firmly engages the interior of the hub portion 110, such that the turbine cap 26 is held in fixed relation to the turbine 22.

In similar fashion, the lower opening 114 of the turbine 22 is then aligned with and pressed onto the axle 78. The hub portion 110 is thereby forced to flex outwardly enough to permit the protrusion 122 to expand and fit over the end 102 of the axle 78. When the protrusion 122 aligns with the groove 94, the hub portion 110 and the protrusion 122 resiliently contract so as to be disposed within the groove 94 and retain the turbine 22 in substantially-fixed axial relation to the axle 78.

The body member 70 is then flexed, as necessary, to fit the cradle 18 about the nozzle body 14, such that the connection members 74 of the cradle 18 are at a point between the reinforced portion 46 and the inlet end 34 of the nozzle body 14. The connection members 74 of the cradle 18 are then aligned with and pressed into the slotted portions 62 in the anchor portions 54 of the nozzle body 14, such that the extension portions 90 of the cradle 18 firmly engage and are disposed adjacent to the lower portion 66.

In operation of the nozzle 10, water enters the nozzle body 14 in a first direction 162 (FIG. 1), via the round fluid passage 30 of the nozzle body 14, flows through the passage 30, and exits via the square outlet end 34. As such, the stream of water is transformed from a round stream to a square stream within the passage 30 of the nozzle body 14. Upon exiting the nozzle body 14, the square stream of water smoothly transitions and spreads over the turbine cap 26 and impacts the blades 112 of the turbine 22, thereby imparting an axial force in the direction 162. The axial force of the water stream is imparted onto the trailing surface 140 of the blades 112, causing the turbine 22 to rotate in a counterclockwise direction 166 (FIG. 1). As the turbine 22 spins, the blades 112 and the leading edges 134 of the blades 112 essentially fling the water outwardly. Because the water stream impacts the turbine 22 in a square shape, and because of the geometry of the turbine 22, the water is flung outwardly in a square pattern as well. Water impacting the top surface 141 of the turbine 22 is directed across the top surface 141 and outwardly from the blades 112.

Stated otherwise, the stream of water is forced through the substantially V-shaped openings in the turbine 22. The geometry of the turbine 22 allows more water to flow as these openings widen away from the hub portion 110, effectively balancing the hydraulics and assisting with even water loading. As will be appreciated by those skilled in the art, the substantially V-shaped openings between the blades 112 are effectively longest when they cross the corner or vertex of the square outlet end 38 of the nozzle body 14, and are effectively shortest when they cross the sides of the square outlet end 38. As such, as the turbine 22 spins below the square water stream, it creates a longer spray of water at the corners and progressively shorter sprays approaching the side of the square water pattern. Besides the width of the openings being altered, the length 139 of each blade may be modified depending on water flow design requirements.

Referring now to FIGS. 5A-5D, shown therein is another embodiment of a turbine 150. The turbine 150 is constructed similarly to the turbine 22 shown in FIGS. 4A-4D with the exception that the blades 152 are substantially equal in length 154 though longer than the length 139 of the blades 112 of the turbine 22. The turbine cap 156 is smaller than the turbine cap 26 due to the distance with which the blades 152 begin relative to a hub portion 160. Additionally, the top surface 158 has a larger surface area than the trailing surface 140 of the turbine 22 and the top surface 158 is tapered such that the blades 152 are thicker towards the hub portion 160, and progressively thin towards the terminal ends of the blades. It will be understood that due to the tapering shape of the blades 152, water flowing over the blades 152 will be directed more downwardly than water flowing over the substantially horizontal top surface 141 of the blades 112 of the turbine 22 (see FIG. 4A-4B). The turbine 150 also includes a plurality of vertically disposed fins 164 positioned below the blades 152. The plurality of vertically disposed fins 164 operate to further disperse water flowing downwardly through the blades 152. Although the vertically disposed fins 164 have been disclosed as being included in this embodiment, the vertically disposed fins 164 may be included with any of the turbine embodiments shown in FIGS. 4A-4D, 6A-6D, 7A-7D and/or 8A-8D. It will also be understood that the turbine 150 may be utilized in applications where the spray nozzle 10 is positioned at a fall distance 171 ranging from approximately one inch to fifteen inches, although the spray nozzle may be positioned at any fall distance 171 (FIG. 13).

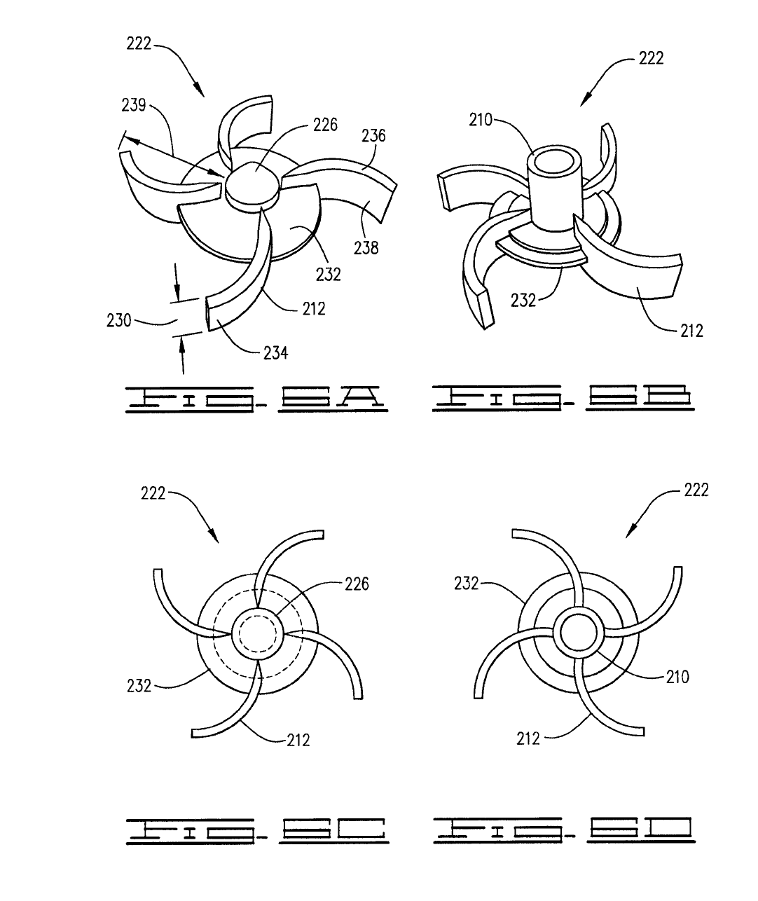

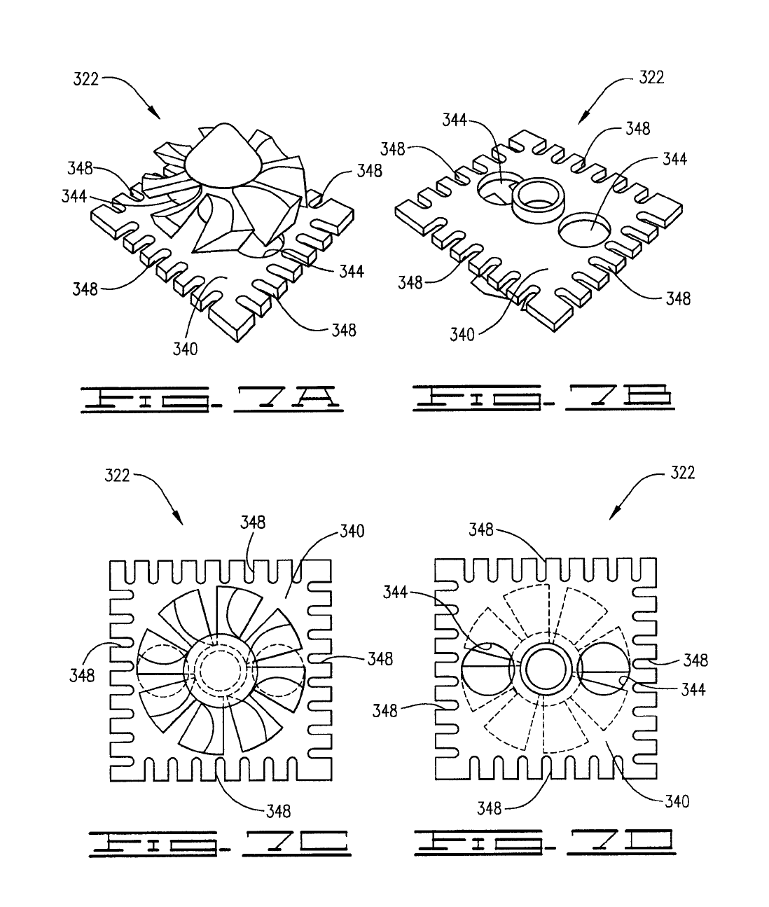

Referring now to FIGS. 6A-6D, collectively shown therein is another embodiment of a turbine 222 for use in low fluid flow applications (i.e., five gallons per minute to 25 gallons per minute), such as waste water treatment. The turbine 222 is provided with four blades 212 which are substantially symmetrical and are spaced at substantially equal angular increments about a deflector member 232. In this embodiment, the blades 212 are fabricated with an arcuate profile. It will be understood that the angle of the arcuate profile may vary with design requirements (i.e., fluid flow rates, distance, and the like). The deflector member 232 is connected to the hub portion 210 and includes an angled circular disk positioned below the turbine cap 226. The angle of the deflector member 232 is obtuse relative to the nozzle body 214. Each blade 212 has a height 230, a leading edge 234, a top edge 236, a trailing edge 238, and a length 239. The leading edge 234 is formed with a substantially constant angle along the length of the blade 212. The angle of the leading edge 234 is between about 90 degrees and about 75 degrees, and most about 90 degrees. The angle of the trailing edge 238 is between about 45 degrees and about 85 degrees, more between about 45 degrees and about 75 degrees, and most about 75 degrees. It will be understood that the top edge 236 is a vertex formed from the adjoining of the top of the leading edge 234 and the top of the trailing edge 238. The length 239 of each blade 212 is shown nearest to the hub portion 210 at which the leading edge 234 terminates, and may occur at any distance away from the hub portion 210. However, it will be understood that the length 239 of each blade may be varied dependent upon fluid flow rates to be encountered.

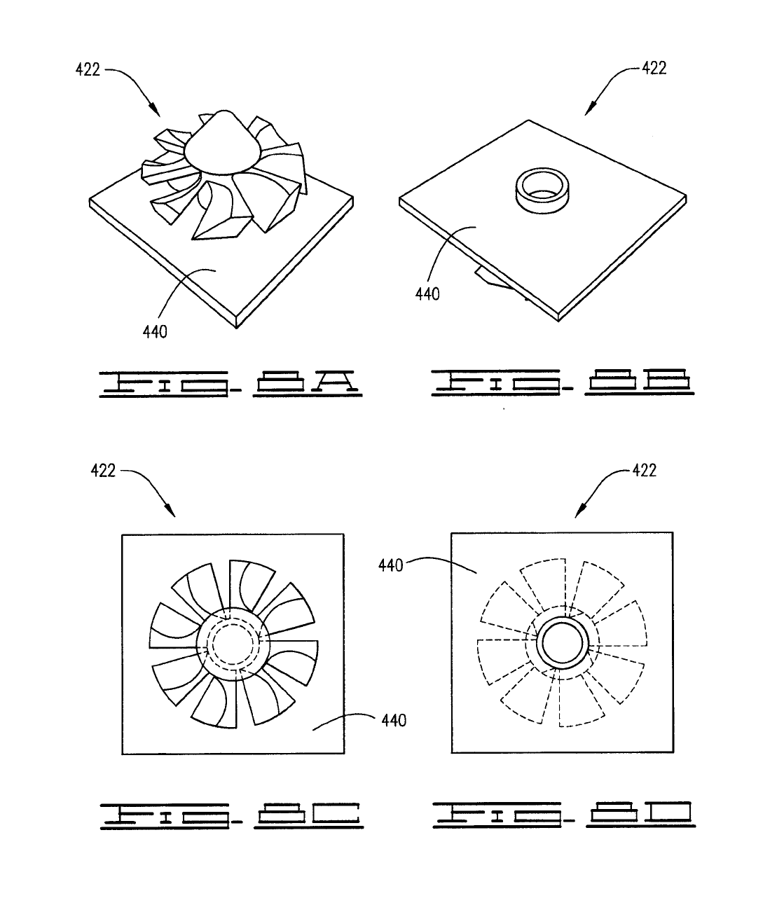

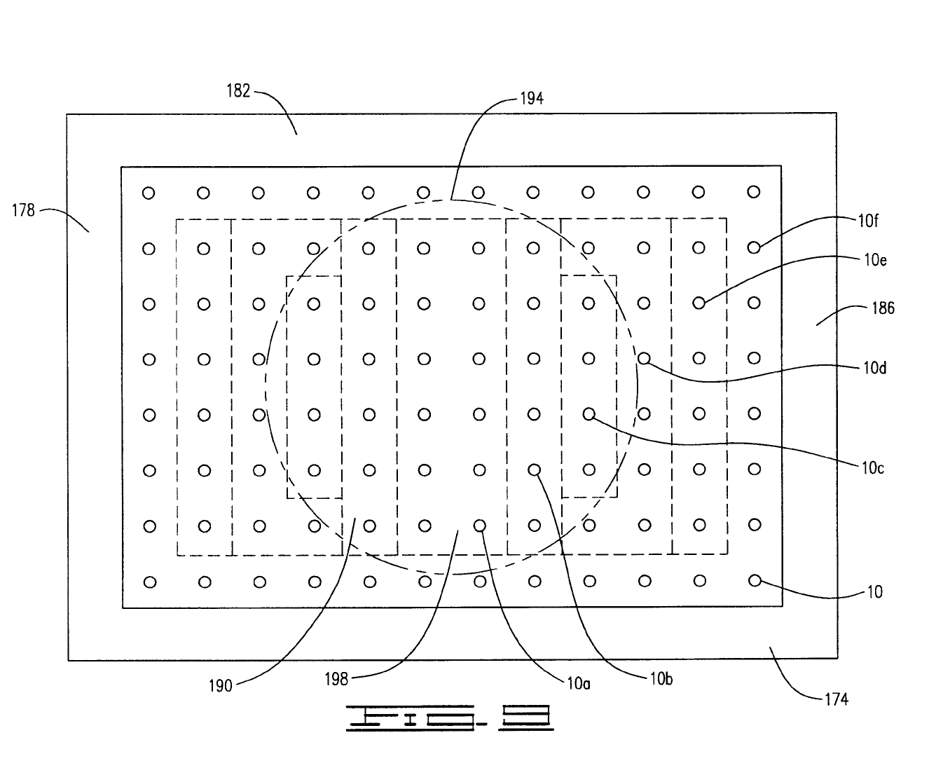

Referring now to FIGS. 7A-7D, shown therein is another embodiment of a turbine 322. The turbine 322 may optionally include one or more deflector plates 340. The deflector plate 340 is positioned below the turbines 322. The deflector plate 340 may be formed in a variety of different geometrical configurations, for example, circular, square, rectangular, and triangular. In one embodiment, the outer perimeter of the deflector plate 340 is greater than the outer perimeter of the turbine 322, although it will be understood that deflector plates 340 and turbine 322 of varying outer perimeters are also likewise contemplated. The deflector plate 340 is attached to the hub portion 310. The deflector plate 340 functions to disperse the fluid that passes through and around the turbine 322. To aid in uniform dispersion of the fluid, the deflector plate 340 may include a plurality of apertures 344 and/or notches 348 along the edges of the deflector plate 340 which have varying geometrical configurations, for example, circular, rectangular, and/or square. The position of the apertures 344 and/or notches 348 may be varied dependent upon fluid flow rates to be encountered.

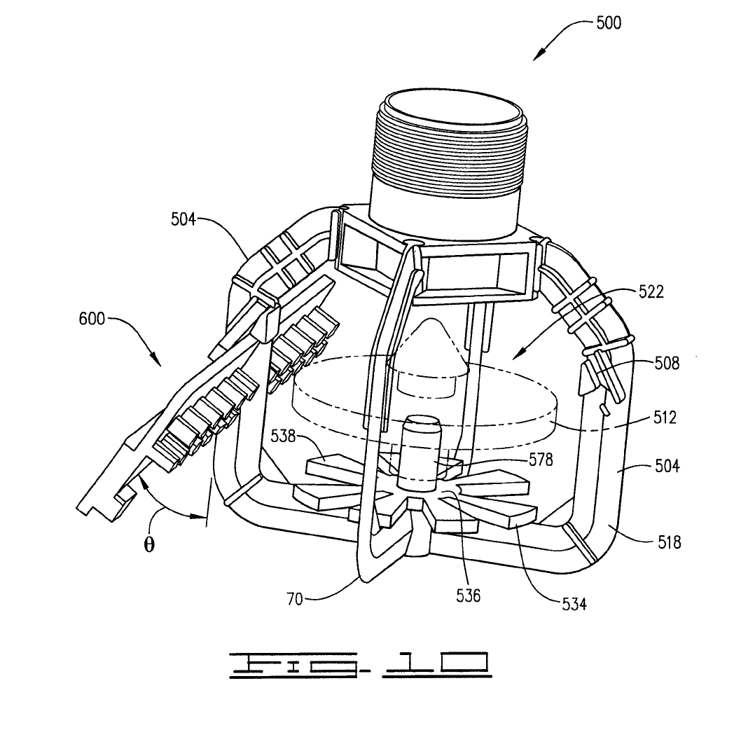

Referring now to FIGS. 8A-8D, shown therein is another embodiment of a turbine 422. The turbine 422 may optionally include one or more deflector plates 440 similarly constructed to the deflector plate 340 shown in FIGS. 7A-7D with the exception that the deflector plate 440 does not include apertures or notches.

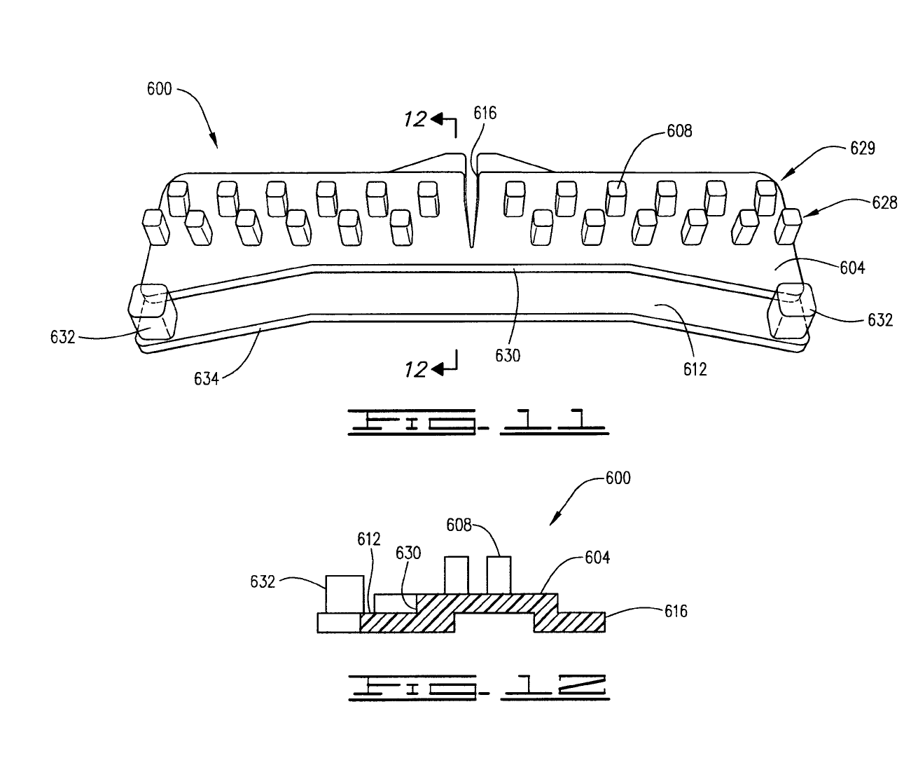

Referring now to FIG. 9, shown therein is a schematic representation of a cooling tower cell 170 with a plurality of spray nozzles 10 constructed in accordance with the present invention positioned for distributing water across a fill material (not shown). Cooling towers typically include a cooling tower frame having first, second, third and fourth sides 174, 178, 182 and 186, respectively. The four sides 174-186 form a rectangular frame that defines an air passageway 190. Each of the sides include air inlet openings (not shown) in the lower portion thereof for allowing air to be drawn through the side walls 174-186 and into the air passageway 190.

Layers of corrugated fill material 192 (FIG. 13) are positioned within the air passageway 190. The upper end of the frame supports an exhaust fan (not shown). A pump pulls water from a source through a supply line to a horizontal header to which the spray nozzles 10 are connected. Water is distributed by the spray nozzles 10 across the uppermost layer of fill material. The exhaust fan pulls air in through the air inlets and up through the air passageway 190 and layers of fill material in counterflow to the downwardly flowing water thereby cooling the water which is then collected in a basin and re-circulated or otherwise used as desired.

In a typical cooling tower cell, the exhaust fan will cause air to migrate upwardly through the cooling tower cell 170. The flow of air will have a tendency to be greater along a fan area 194 defined generally by a cylinder extending downward through the air passageway 190 from the perimeter of the fan. Air will travel along the path of least resistance and will tend to migrate upward in a circular pattern within the fan area 194. This central flow of air will starve the outer areas of the cooling tower cell 170 of air thereby significantly reducing the ability to achieve a balanced air to water mixture. The construction of cooling towers is further disclosed in U.S. Pat. No. 5,152,458, the entire contents of which are hereby expressly incorporated herein by reference.

With respect to the nozzle 10 described above, the size and geometry of the nozzle body 14, cradle 18, the turbine 22 and/or the tubular adapter 36 may be modified to produce different water flow rates through each spray nozzle 10. This permits the flow rates of each spray nozzle 10 to be controlled in an effort to better balance the air to water mixture. Because the exhaust fan will cause air to migrate upwardly through the cooling tower cell 170 along the fan area 194, it may be preferable to create a heavy water loading zone 198 in the fan area 194 and thus force a portion of the air out toward the perimeter of the cooling tower cell 170 to interact with the water distributed by the spray nozzles 10 outside the fan area 194. Heavy water loading may be achieved by using spray nozzles 10a with a higher flow rate located along a diametric axis 198 of the fan area 194. The water loading may be progressively decreased outwardly toward the perimeter walls of the cooling tower cell 170 by using nozzles 10a, 10b, 10c, etc., with progressively lower flow rates. By way of example, spray nozzles 10b may have a flow rate that is about 10% less than the flow rate of the spray nozzles 10a and thus form a water loading zone 202. Spray nozzle 10c may have a flow rate that is about 20% less than the flow rate of the spray nozzle 10a and thus form a water loading zone 206.

Outside the fan area 194, spray nozzles 10d may have a flow rate that is about 70% less than the flow rate of the spray nozzles 10a and thus form a water loading zone 210. Spray nozzles 10e may have a flow rate about 80% less than the flow rate of the spray nozzles 10a and thus form a water loading zone 214. Finally, spray nozzles 10f may have a flow rate about 90% less than the flow rate of the spray nozzles 10a and thus form a water loading zone 218 along the perimeter of the air flow passageway 190.

While an example of a water loading design has been illustrated, it will be appreciated that the number of spray nozzles in each water loading zone, the configuration of the water loading zones, as well as the respective flow rates of the various nozzles 10 may be varied depending on numerous factors including the size and configuration of the cooling tower cell and the size of the fan. For example, in some embodiments nozzles 10 having equal flow rates may be employed to achieve an even water distribution over the entire area 170.

Prior art nozzles may require as much as two feet of vertical clearance above the fill media 192 (FIG. 13). This large fall distance 171 (FIG. 13) between the nozzle orifice and the fill media 192 allows small micro water droplets to be generated from the splash action as the water from a nozzle bounces against the fill media 192 (FIG. 13). These micro droplets are caught up in the exhaust air stream, creating drift losses. In contrast, the nozzle 10 of the present invention is designed to operate with as little as three inches of space above the fill media 192, reducing the amount of micro droplets. This feature may reduce drift loss, allow for the installation of additional fill, reduce required pump head, and reduce structure height in new construction.

In one embodiment, existing up-spray systems may be converted into down-spray systems using the existing header by cutting the laterals, rotating the existing laterals 180 degrees, and re-installing them with the nozzles 10 in place of the prior up-spray nozzles. Such an upgrade of existing up-spray systems may be made possible by the shorter fall distance of the nozzle 10, described above.

While the spray nozzle 10 of the present invention has been disclosed for use in a cooling tower, it will be understood that the spray nozzle 10 of the present invention may also be used in any fluid distributing application including, for example, lawn sprinklers, fluid evaporation, waste water treatment applications, desalinization applications, pond aeration, and even for distributing fluid solids, such as grain.

Referring now to FIG. 10, shown therein is another embodiment of a spray nozzle 500 having a deflector plate 600. The spray nozzle 500 is constructed similarly to the spray nozzle 10 with the exception that the turbine 522 is shown schematically, as the turbine 522 is interchangeable and may include any one of the turbines shown in FIGS. 4A-4D, 5A-5D, 6A-6B, 7A-7D and 8A-8D. The spray nozzle 500 is constructed similarly to the spray nozzle 10 as shown in FIGS. 1-4, with the exception of the addition of C-shaped body member 504 to the cradle 518. The C-shaped body member 504 is constructed similarly to the C-shaped body member 70 as shown in FIGS. 4-6. The addition of the second C-shaped body member 504 improves stability and reduces warping and twisting of the C-shaped body members 504 resulting from exposure to heat, physical forces and combinations thereof. The C-shaped body member 504 is provided with a deflector plate engagement member 508 which is designed to cooperate with the deflector plate 600 to secure the deflector plate 600 thereon. The deflector plate 600 is pivotally connectable at various angles θ relative to the C-shaped body member 504 such that the angle θ may be changed. The angle θ of the deflector plate 600 will vary according to design requirements, for example, flow rate, distance from fill media 192 (FIG. 13), distance from a cooling tower side, and the like. The angle θ of the deflector plate 600 should be set at a level such that the water deflected by the deflector plate 600 is directed away from the walls of the cooling tower towards the fill media 192, and most preferably toward the intersection of the fill media 192 and the wall. It will be understood that at least a portion of the deflector plate 600 should be positioned at least partially above the blades 512 of the turbine 522 to prevent water bypassing the deflector plate 600. The spray nozzle 500 includes a void deflector 530 configured to deflect and disperse the water flowing through the blades 512 of the turbine 522 which would naturally flow over portions of the C-shaped body members 70 and 504 which are positioned below the blades 512 of the turbine 522 and cause voids in the square shaped spray pattern. In other words, the void deflector 530 enhances the hydraulic balancing of the spray nozzle 500 by substantially eliminating voids in the substantially square shaped spray pattern caused by the C-shaped body members 70 and 504. The void deflector 530 is provided with a plurality of fins 534 extending laterally from a central hub portion 536. The plurality of fins 534 are constructed such that the width of the fins 534 increases as the fin body 538 extends away from the hub portion 536. The hub portion 536 is slidably engaged with the axle 578 of the spray nozzle. To properly position the void deflector 530, all sections of the C-shaped body members 70 and 504 positioned below the turbine 522 may be substantially covered by at least one of the fins 534 of the void deflector 530.

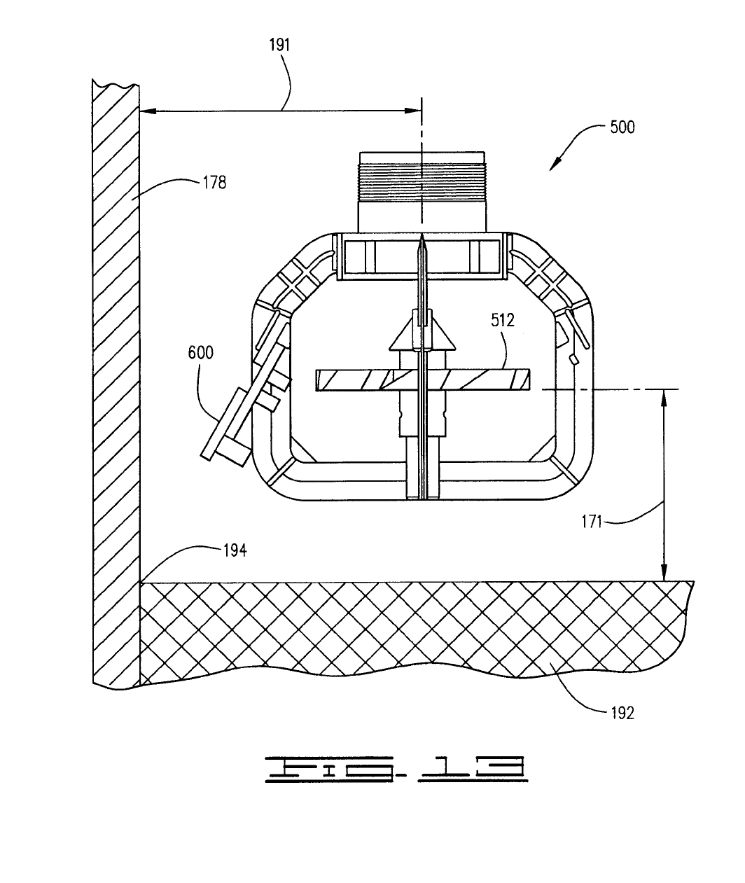

Referring now to FIGS. 10-13, shown therein is the deflector plate 600 which is connectable to a spray nozzle (see FIG. 10). The deflector plate 600 may be utilized with peripheral spray nozzles in cooling towers, such as the cooling tower 170 illustrated in FIG. 9. Peripheral spray nozzles, such as spray nozzles 10f in FIG. 9, include spray nozzles that are positioned adjacent to one of the sides 178 of the cooling tower. The spray nozzle 500 is spaced apart from the side 178 at a distance 191. The distance 191 of the spray nozzle 500 from the side 178, the fall distance 171 and the angle θ of the deflector plate 600 may be independently adjusted such that the water dispersed off of the deflector plate 600 impacts the fill media 192 at a location 194 at or near the intersection of the fill media 192 and close to the side 178 while minimizing or eliminating the dispersion of water onto the side 178. The deflector plate 600 serves to direct water away from the side 178 and onto the fill media 192, thereby reducing what is known as “wall water effect.” The wall water effect arises when spray nozzles adjacent to the walls of the cooling tower spray water directly onto the walls themselves rather than dispersing the water through the air, outwardly and downwardly towards a media. Water sprayed onto the walls of the cooling tower possesses lower heat transfer potential than water evenly dispersed through the air, due in part to a reduction in the surface area of the water.

The deflector plate 600 generally includes a first deflector surface 604, a plurality of flow disrupting members 608, a second deflector surface 612, and a spray nozzle connector 616. The deflector plate 600 is preferably fabricated to have an arcuate configuration along its longitudinal axis. The flow disrupting members 608 extend from the first deflector surface 604 and are shown to be positioned along the length thereof in a two row configuration. A first row 628 of flow disrupting members 608 is shown as offset relative to a second row 629 of flow disrupting members 608. The flow disrupting members 608 are fabricated having a substantially square geometry, although other geometries, for example, triangular, cylindrical or rectangular, may likewise be utilized. Also, one or more flow disrupting members 608 may be positioned at each of the lower corners 632 of the deflector plate 600.

To further facilitate diffusion of water contacting the deflector plate 600, the second deflector surface 612 is set back from the first deflector surface 604 to create a first edge 630. As water flows from the edge 630, the water will have a tendency to disperse or otherwise “break-up.” The second deflector surface 612 in turn serves to deflect a portion of the water that disperses from the edge 630. A lower edge 634 of the second deflector surface 612 serves to further disperse water flowing from the second deflector surface 612. While only two deflector surfaces are illustrated herein, it will be appreciated that the deflector plate 600 may be constructed to have any number of deflector surfaces formed in a stair step fashion. Also, the second deflector surface 612 may be formed continuous with the first deflector plate 604, as shown, or alternatively, openings may be provided between the first deflector surface 604 and the second deflector surface 612 to permit air to mix with the water flowing off the edge 630. The edge 630 of the first deflector surface 604 and the lower edge 634 of the second deflector surface 612 are preferably constructed to have angled portions. The deflector plate 600 is pivotally connectable to a spray nozzle via the spray nozzle connector 616 (see FIG. 10)

From the above description it is clear that the present invention is well adapted to carry out the objects and to attain the advantages mentioned herein as well as those inherent in the invention. While presently preferred embodiments of the invention have been described for purposes of this disclosure, it will be understood that numerous changes may be made which will readily suggest themselves to those skilled in the art and which are accomplished within the spirit of the invention disclosed and as defined in the appended claims.

What is claimed is:

1. A spray nozzle, comprising:
a tubular nozzle body having a fluid passage defined by an annular surface, at least a portion of the annular surface having a substantially square shaped configuration such that when a fluid is communicated through the nozzle body, the portion of the annular surface having a substantially square shaped configuration causes the fluid exiting the nozzle body to exit as a substantially square shaped column of fluid; and
a turbine positioned below the nozzle body in axial alignment with the fluid passage and rotatably connected to the tubular nozzle body, the turbine having a plurality of radially extending blades, each of the plurality of radially extending blades having a leading edge and a trailing edge such that when the square shaped column of fluid exiting the nozzle body contacts the turbine, the turbine is caused to rotate and thereby distribute the square shaped column of fluid into a substantially square shaped spray pattern.

2. The spray nozzle of claim 1, further comprising a tubular adapter slidably inserted in the nozzle body to reduce the flow area of the fluid passage.

3. The spray nozzle of claim 1, further comprising a diverter cap positioned between and in axial alignment with the nozzle body and the turbine, the diverter cap shaped to divert the substantially square shaped column of fluid into contact with the plurality of radially extending blades of the turbine.

4. The spray nozzle of claim 1, wherein the leading edge of each of the plurality of radially extending blades has a length and wherein the length of the leading edge of each blade is different from the length of the leading edge of an adjacent blade.

5. The spray nozzle of claim 1, wherein the trailing edge is disposed at an angle which is smaller than the angle of the leading edge.

6. The spray nozzle of claim 1, wherein each of the plurality of radially extending blades includes a trailing surface having a curved portion constructed to receive a force imparted onto the blades by the square shaped column of water to rotate the turbine.

7. The spray nozzle of claim 1, further comprising a deflector plate connected to a portion of the tubular nozzle body so as to effect a deflector plate operating change in the trajectory of at least a portion of the fluid dispersed by the turbine.

8. The spray nozzle of claim 7, wherein the deflector plate has a plurality of spaced apart flow disrupting members extending from a first deflector surface of the deflector plate.

9. The spray nozzle of claim 8, wherein the deflector plate further has a second deflector surface which is offset from the first deflector surface to define a first edge.

10. The spray nozzle of claim 9, wherein the second deflector surface of the deflector plate includes a lower edge offset from the first edge.

11. The spray nozzle of claim 10, wherein the first deflector surface and the second deflector surface are spaced apart from one another so as to permit air to mix with a fluid flowing off of the first edge.

12. A cooling tower cell, comprising:
a cooling tower frame defining an air passageway;
a fill material extending across the air passageway; and
a fan supported at the upper end of the cooling tower frame to pull air up through the air passageway, the fan defining a fan area extending below the fan;
a plurality of spray nozzles for delivering a supply of water over the fill material, each of the spray nozzles comprising:
a tubular nozzle body having a fluid passage defined by an annular surface, at least a portion of the annular surface having a substantially square shaped configuration such that when a fluid is communicated through the nozzle body, the portion of the annular surface having a substantially square shaped configuration causes the fluid exiting the nozzle body to exit as a substantially square shaped column of fluid; and
a turbine positioned below the nozzle body in axial alignment with the fluid passage and rotatably connected to the tubular nozzle body, the turbine having a plurality of radially extending blades, each of the plurality of radially extending blades having a leading edge and a trailing edge such that when the square shaped column of fluid exiting the nozzle body contacts the turbine, the turbine is caused to rotate and thereby distribute the square shaped column of fluid into a substantially square shaped spray pattern.

13. The cooling tower cell of claim 12 wherein the spray nozzles are arranged to create a plurality of water loading zones and wherein the water loading zones include a central water loading zone positioned within the fan area and a plurality of outer water loading zones positioned outside the fan area, the spray nozzles of the central water loading zone distributing water at a greater rate than the spray nozzles of the other water loading zones so as to cause a portion of the air being pulled through the fan area by the fan to be deflected outside the fan area to interact with the water distributed within the other water loading zones.

14. The cooling tower cell of claim 13, wherein the cooling tower frame is defined by a plurality of sides and wherein each of the spray nozzles adjacently disposed to the plurality of sides includes a deflector plate releasably connectable to the spray nozzles, the deflector plate positioned between the spray nozzle and the side of the cooling tower frame to change the trajectory of the fluid dispersed in the direction of the deflector plate by the turbine to substantially reduce the fluid contacting the plurality of sides of the cooling tower frame.
